(19) United States
(12) Patent Application Publication
(10) Pub. No.: US 2005/0126065 A1
(43) Pub. Date: Jun. 16, 2005

(54) Lure

(75) Inventor: Katsuo Ishii, Matsudo City (JP)

Correspondence Address: BURR & BROWN, PO BOX 7068, SYRACUSE, NY, 13261-7068, US

(73) Assignee: Yugen Kaisha Ishii Kogei, Matsudo City (JP)

(21) Appl. No.: 10/736,222

(22) Filed: Dec. 15, 2003

(51) Int. Cl. A01K 85/00

(52) U.S. Cl. 43/42.24

(57) ABSTRACT

A lure having a shape that represents a small fish, a bug, or the like, including a tail fin part, a dorsal fin part or a pectoral fin part made of soft material like synthetic resin, rubber or the like, and the remaining portion made of hard material.

### BACKGROUND OF THE INVENTION

1. Field of the Invention

This invention relates to a fishing lure comprising hard material, and more particularly to a lure wherein some parts are made of soft material so that the texture of the lure becomes more like an actual fish when bitten, and further, the movement thereof is arranged to simulate the flexing movement of a fish. Therefore, better fishing efficiency can be expected with this lure than with conventional lures.

2. Description of the Related Art

In the past, a conventional lure has been known in the form of a jig head outfitted with a rubber, a skirt, a plastic bait, a feather or so, or as a whole form composed of hard material. However, none of these conventional lures necessarily provides satisfaction in catching fish, and a further problem with the conventional lures is that the usage thereof requires technique.

### SUMMARY OF THE INVENTION

The present invention is to provide a lure solving the above problem.

In order to achieve the above purpose, the shape of the lure set forth in the present invention represents a small fish, a bug, or the like, and the lure is comprised of soft material like synthetic resin, rubber or the like, to form a part of the lure, such as a tail fin part, a dorsal fin part or a pectoral fin part, and is comprised of hard material to form the rest of the parts of the lure.

### BRIEF DESCRIPTION OF THE DRAWING

For a fuller understanding of the nature and objects of the invention, reference should be made to the following detailed description of a preferred mode of practicing the invention, read in connection with the accompanying drawing, in which:

FIG. 1 is a side view of the embodiment, showing a whole lure.

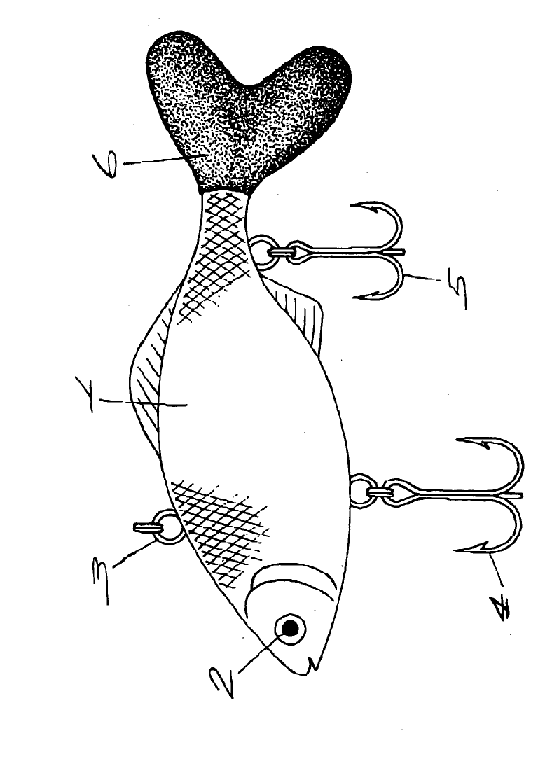

### DETAILED DESCRIPTION OF THE INVENTION

Referring to the embodiment shown in the drawing, a lure body 1 which is formed in a shape of a small fish without a tail fin comprised of hard plastic material is outfitted with eyes 2, an eyelet 3 and fish hooks 4 and 5. Further, a tail fin 6 is separately comprised of soft synthetic resin so that the texture thereof becomes like an actual fish when bitten. This tail fin 6 is then fixed onto the above fish body 1 so that the whole shape represents a small fish with a tail fin.

Furthermore, the present invention, for example, can be formed and provided in a form of a bug of which legs are comprised of soft synthetic resin. The soft synthetic resin also can be exchanged with some new or different material. The present invention can also be outfitted with a sinker and/or formed with a rip. Therefore, it is obvious to those skilled in the art that changes and modifications can be made without departing from this invention in its broader aspects.

The lure set forth in the present invention as described in the above, is a lure of which shape represents a small fish, a bug, or the like, comprising soft material like synthetic resin, rubber or the like, to form a part of the lure, such as a tail fin part, a dorsal fin part or a pectoral fin part, and hard material to form the rest of the parts of the lure. The soft material part of the lure creates the texture thereof to be like an actual fish when a fish bites on the lure. Additionally, because of the water stream and/or water pressure, the conventional lures have been comprised of hard material or feathers, so the movements of the conventional lures do not accurately simulate Teal fish. However, the lure according to the present invention with the soft material comprised therein can simulate the flexing movement of a real fish, therefore, it is notably appealing to a fish to be caught. This means that better fishing efficiency can be expected with this lure than with the conventional lures.

The presence of this soft material part in a lure creates an originality and novelty which can complete the aim that is to solve the initial problem of mannerism.

While the present invention has been particularly shown and described with reference to the preferred mode as illustrated in the drawing, it will be understood by one skilled in the art that various changes in detail may be effected therein without departing from the spirit and scope of the invention as defined by the claim.

1. A lure shaped to represent a small fish comprising:
a tail fin part;
at least one of a dorsal fin part and a pectoral fin part; and
a body portion, wherein the tail fin part and at least one of the dorsal fin part and the pectoral fin part consist of a soft material and the body portion consists of a hard material.

2. A lure shaped to represent a bug comprising legs consisting of a soft material and a body consisting of a hard material.
